(19) United States
(12) Patent Application Publication
(10) Pub. No.: US 2024/0035841 A1
(43) Pub. Date: Feb. 1, 2024

(54) NAVIGATION DISPLAY SYSTEM

(71) Applicant: NISSAN NORTH AMERICA, INC., Franklin, TN (US)

(72) Inventors: Stefan WITWICKI, San Carlos, CA (US); Erik ST. GRAY, Tacoma, WA (US); Takehito TERAGUCHI, Cupertino, CA (US); Kyle WRAY, Fremont, CA (US)

(21) Appl. No.: 17/877,873

(22) Filed: Jul. 29, 2022

(51) Int. Cl. G01C 21/36

(52) U.S. Cl. CPC G01C 21/367

(57) ABSTRACT

A vehicle includes a user input interface, an electronic display device and a processor. The user input interface is configured to allow a user to input one or more burden conditions of the user. The electronic display device is positioned in an interior compartment of the vehicle. The processor is programmed to control the electronic display device to display one or more route selections, the one or more route selections being based on the burden conditions.

### BACKGROUND

### Technical Field

The present disclosure generally relates to a navigation display system. More specifically, the present disclosure relates to a navigation display system that can account for one or more burden conditions of the driver and or road conditions.

### Background Information

A vehicle may traverse a portion of a vehicle transportation network (e.g., a road). Traversing the portion of the vehicle transportation network may include generating or capturing, such as by a sensor of the vehicle, data, such as data representing an operational environment, or a portion thereof, of the vehicle.

### SUMMARY

In view of the state of the known technology, one aspect of the present disclosure is to provide a vehicle comprising a user input interface, an electronic display device and a processor. The user input interface is configured to allow a user to input one or more burden conditions of the user. The electronic display device is positioned in an interior compartment of the vehicle. The processor is programmed to control the electronic display device to display one or more route selections, the one or more route selections being based on the burden conditions.

In view of the state of the known technology, one aspect of the present disclosure is to provide a method for displaying vehicle route selections. The method comprises acquiring burden conditions inputted to a user input interface by a user. The method further comprises acquiring real-time information from an on-board satellite navigation device in communication with a global positioning system unit. The method further comprises acquiring crowdsourced information from a telematics control unit in wireless communications with at least one of a cloud services and a vehicle network. The method further comprises controlling an electronic display device to display one or more route selections, the one or more route selections being based on the burden conditions, the real-time information and the crowdsourced information.

### BRIEF DESCRIPTION OF THE DRAWINGS

Referring now to the attached drawings which form a part of this original disclosure:

FIG. 1 is a top plan view of a vehicle equipped with a navigation display system that is schematically illustrated;

FIG. 2 is a schematic view of the components of the navigation display system;

FIG. 3 is a schematic view of the vehicle as being in communication with a GPS server, a cloud server and a vehicle network;

FIG. 4 is a schematic view of the operations of the navigation display;

FIG. 5 is a portion of a passenger compartment of the vehicle equipped with a display device of the navigation display system;

FIG. 6 is a sample navigation route that can be displayed by the display device;

FIG. 7 is a sample dataset of complexity grades for navigation scenarios that can be prestored in a computer-readable medium of the navigation display system; and

FIG. 8 is a flowchart illustrating steps that can he carried out by a processor of the navigation display system.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

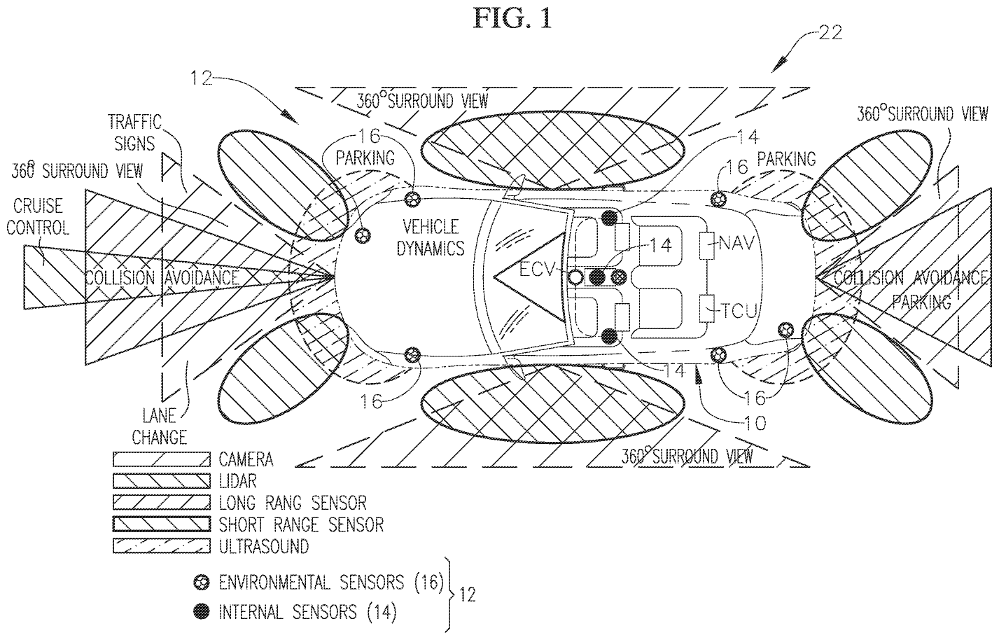

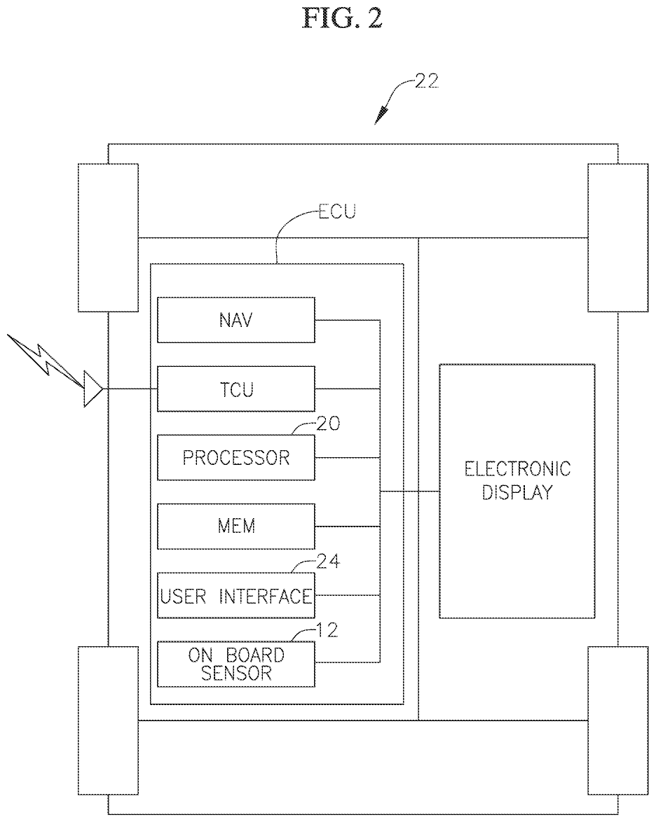

Referring initially to FIG. 1, a vehicle 10 is schematically illustrated as being equipped with a plurality of control modules for navigation assistance. In the illustrated embodiment, the vehicle 10 is equipped with an on-board satellite navigation device NAV and a telematics control unit TCU, as best seen in FIGS. 1 and 2. The on-board satellite navigation device NAV and a telematics control unit TCU are considered examples of control modules for navigation assistance. The vehicle 10 is further equipped with an on-board sensor network 12 that monitors both internal and external conditions of the vehicle 10. That is, the on-board sensor network 12 includes internal sensors 14 to monitor conditions regarding the vehicle 10 interior, such as the vehicle's 10 passenger compartment. The on-board sensor network 12 further includes environmental sensors 16 that monitors conditions regarding the vehicle 10 vicinity, as will be further discussed below.

For example, the vehicle 10 can be equipped with one or more unidirectional or omnidirectional external cameras that take moving or still images of the vehicle 10 surroundings. In addition, the external cameras can be capable of detecting the speed, direction, yaw, acceleration and distance of the vehicle 10 relative to a remote object. The environmental sensors 16 can also include infrared detectors, ultrasonic detectors, radar detectors, photoelectric detectors, magnetic detectors, acceleration detectors, acoustic/sonic detectors, gyroscopes, lasers or any combination thereof. The environmental sensors 16 can also include object-locating sensing devices including range detectors, such as FM-CW (Frequency Modulated Continuous Wave) radars, pulse and FSK (Frequency Shift Keying) radars, sonar and Lidar (Light Detection and ranging) devices. The data from the environmental sensors 16 can he used to determine information about the vehicle's 10 vicinity, as will be further described below.

Preferably, the internal sensors 14 includes at least one internal unidirectional or omnidirectional camera positioned to detect behavior of one or more passengers in the passenger compartment. The on-board sensor network 12 further includes at least one internal microphone positioned to detect behavior of one or more passengers in the passenger compartment. The internal sensors 14 are provided to detect the behavior of the vehicle's 10 driver and/or passenger(s). For example, the internal sensors 14 can detect a state of whether the driver is distracted, unfocused or unresponsive. Cameras and microphones can detect whether the driver is engaged with a conversation with another passenger and is not paying attention to the navigation system or road conditions.

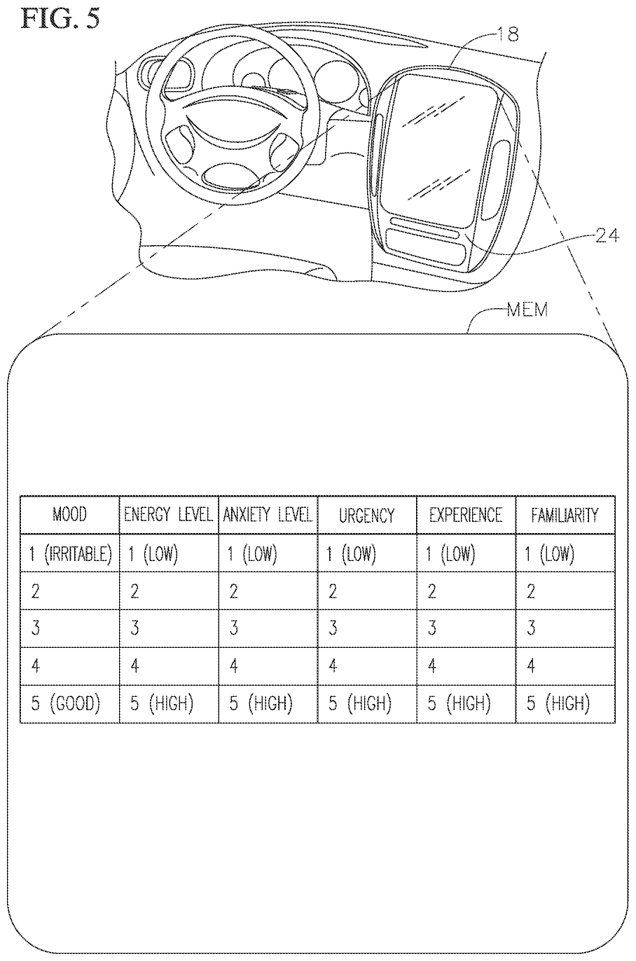

As shown in FIGS. 5 to 9, the vehicle 10 is further equipped with an electronic display device 18 configured to display route selection(s) to the driver. The electronic display device 18 is positioned an interior compartment of the vehicle 10. The vehicle 10 is further equipped with an electronic control unit ECU controlling the electronic display device 18 to display route selection(s) based on information received by the on-board sensor network 12, as will be further described. In particular, the ECU includes a processor 20 for controlling the operation of a navigation display system 22 of the vehicle 10, as will be further described. In the illustrated embodiment, the display device 18 is provided as part of the navigation display system 22 for the vehicle 10.

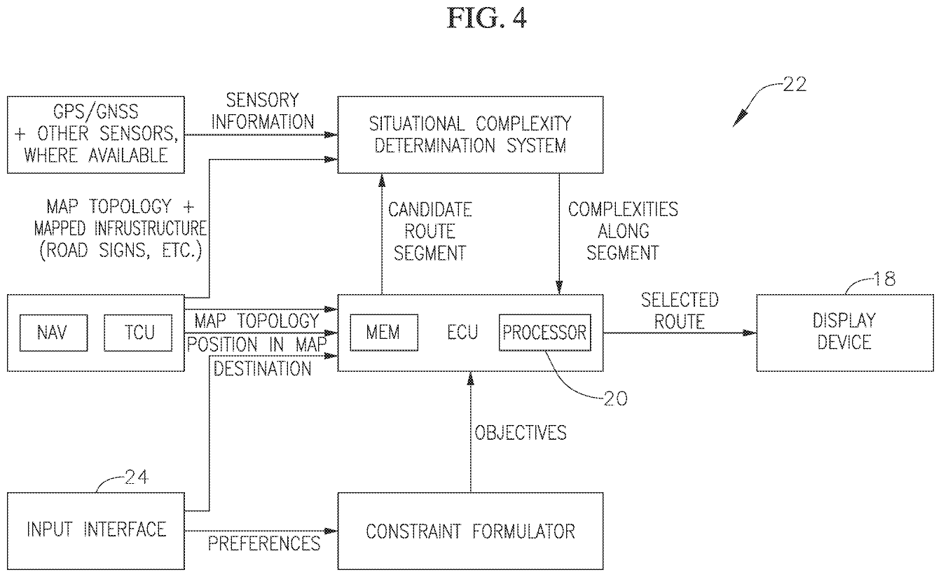

In the illustrated embodiment, the processor 20 is programmed to control the electronic display device 18 to display one or more route selection(s), as seen in FIG. 5. In the illustrated embodiment, the route selection(s) are based on the burden conditions of the driver or the passengers, as will be further described. Additionally, as shown in FIG. 4, the route selection(s) that are displayed can also be based on a determined complexity of the navigation route. Further, the route selection(s) can be based on user preferences inputted via a user interface, as shown in FIG. 4. Further, the route selection(s) are also preferably based on information detected by the sensor network 12, as will be further discussed below.

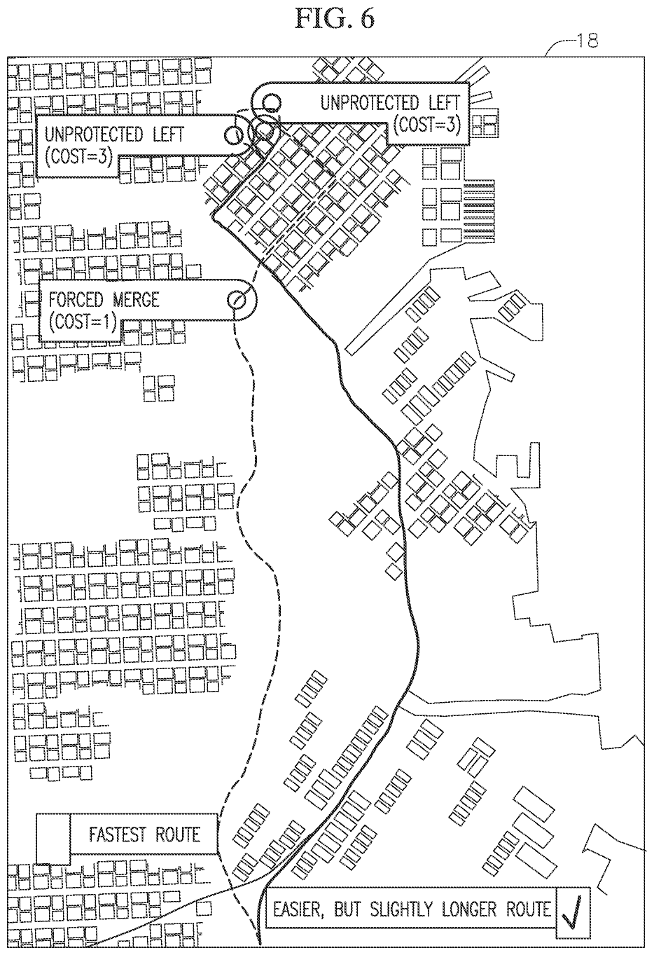

The route selection(s) selected to be displayed are also based on information received by the NAV and the TCU, as will be further described. The processor 20 also controls the electronic display device 18 to display one or more route selection(s) based on information received by the on-board sensor network 12. That is, the processor 20 controls the display device 18 to display information based on a burden condition of the driver or the passenger(s) that is detected by the sensor network 12. As shown in FIG. 6, the electronic display device 18 of the illustrated embodiment is programmed to display a navigation map. Preferably, the route selection(s) are superimposed on the navigation map when displayed on the display device 18.

The navigation display system 22 can also display routes that the processor 20 did not select for recommendation, along with reasons against selections with complex sections highlighted, such as shown in FIG. 6. Therefore, the user then has the option to choose one of the non-selected routes or even to combine elements form more than one of the routing options.

In the illustrated embodiment, the term “route selection(s)” can include illustrated navigation routes, recommended turns and maneuvers and road/navigation information. The route selection(s) can be displayed as in combination of illustrations, schematics, text or icons. In the illustrated embodiment, the processor 20 is programmed to control the electronic display device 18 to display the route selection(s). In particular, the processor 20 is programmed to control the electronic display device 18 to display route selection(s) regarding the condition of the vehicle 10 vicinity based on one or more of the real-time information, the crowdsourced information and the predetermined information, as will be further described below.

In the illustrated embodiment, the term “vehicle vicinity” refers to an area within a two hundred meter distance to a one mile distance of the vehicle 10 from all directions. “Vehicle vicinity” includes an area that is upcoming on the vehicle's 10 navigation course.

Referring again to FIGS. 1 and 2, the vehicle's 10 control modules for navigation assistance will now he further discussed. In particular, the on-board satellite navigation device NAV is in communication with a global positioning system unit (GPS) to acquire real-time information regarding conditions near the vehicle's 10 vicinity. The on-board satellite navigation device NAV can be a global navigation satellite system (GNSS) receiver or GPS receiver that is capable of receiving information from GNSS satellites then calculate the device's geographical position. Therefore, the on-board satellite navigation device NAV acquires GPS information for the vehicle 10.

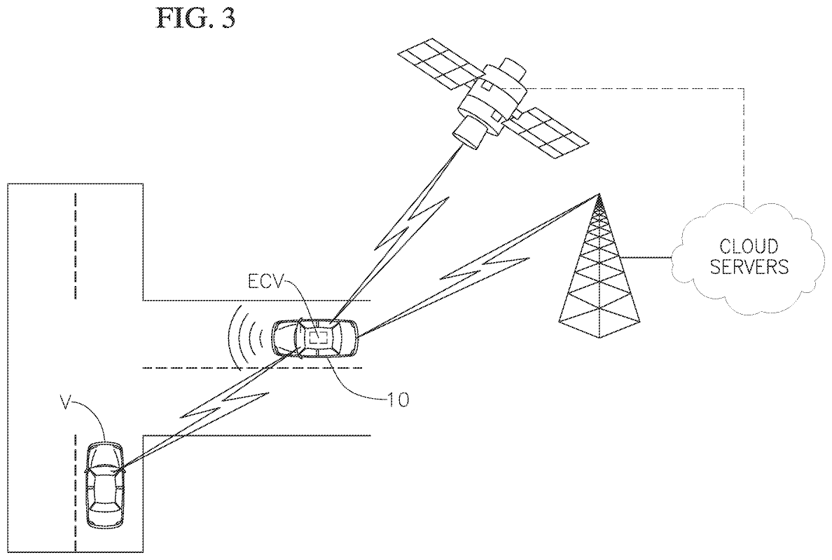

As shown in FIG. 3, the on-board satellite navigation device NAV can also be in communication with a Wide Area Augmentation System (WAAS) enabled National Marine-Electronics Association (NMEA) unit, a radio triangulation unit, or a combination thereof. The on-board satellite navigation device NAV can obtain information that represents, for example, a current heading of the vehicle 10, a current position of the vehicle 10 in two or three dimensions, a current angular orientation of the vehicle 10, or a combination thereof. In this way, the on-board satellite navigation device NAV captures real-time information regarding conditions regarding the vehicle's 10 vicinity.

As seen in FIG. 3, the telematics control unit TCU is in wireless communications to at least one of a cloud server and a vehicle network to upload and receives crowdsourced information regarding conditions near the vehicle's 10 vicinity. The TCU receives the crowdsourced information which are preferably automatically stored into the non-transitory computer readable medium, as will be further described. Data from on-board electronic control units ECU, the on-board sensors can also be transmitted by the TCU to the cloud server or to the vehicle network. That is, the vehicle's 10 location, method of traversal and own experience on a navigation path can also be transmitted to the cloud server or the cloud network.

The TCU is an embedded computer system that wirelessly connects the vehicle to cloud services or other the vehicle network via vehicle 10-to-everything (V2X standards) over a cellular network. The TCU collects telemetry data regarding the vehicle such as position, speed, engine data, connectivity quality etc. by interfacing with various sub-systems and control busses in the vehicle 10. The TCU can also provide in-vehicle 10 connectivity via Wi-Fi and Bluetooth. The TCU can include an electronic processing unit, a microcontroller, a microprocessor 20 or field programmable gate array (FPGA), which processes information and serves to interface with the GPS unit. The TCU can further include a mobile communication unit and memory for saving GPS values in case of mobile-free zones or to intelligently store information about the vehicle's 10 sensor data. Therefore, the memory that stores the information from the TCU can either be part of the TCU or the vehicle's 10 on-board ECU.

Using the TCU, the vehicle 10 can communicate with one or more other vehicle V (e.g., the vehicle network), as seen in FIG. 3. For example, the TCU is capable of receiving one or more automated inter-vehicle 10 messages, such as a basic safety message (BSM), from a remote vehicle V via a network communicated using the TCU. Alternatively, the TCU can receive messages via a third party, such as a signal repeater (not shown) or another remote vehicle V. The TCU can receive one or more automated inter-vehicle messages periodically, based on, for example, a defined interval, such as every 100 milliseconds.

Automated inter-vehicle messages received and/or transmitted by the TCU can include vehicle identification information, geospatial state information (e.g., longitude, latitude, or elevation information, geospatial location accuracy information), kinematic state information (e.g., vehicle acceleration information, yaw rate information, speed information, vehicle heading information, braking system status information, throttle information, steering wheel angle information), vehicle routing information, vehicle operating state information (e.g., vehicle size information, headlight state information, turn signal information, wiper status information, transmission information) or any other information, or combination of information, relevant to the transmitting vehicle state. For example, transmission state information may indicate whether the transmission of the transmitting vehicle is in a neutral state, a parked state, a forward state, or a reverse state.

The TCU can also communicate with the vehicle network via an access point. The access point can be a base station, a base transceiver station (BTS), a Node-B, an enhanced Node-B (eNode-B), a Home Node-B (HNode-B), a wireless router, a wired router, a hub, a relay, a switch, or any similar wired or wireless device. The vehicle 10 can communicate with the vehicle network via the NAY or the TCU. In other words, the TCU can be in communication via any wireless communication network such as high bandwidth GPRS/1XRTT channel, a wide area network (WAN) or local area network (LAN), or any cloud-based communication, for example. Therefore, using the TCU, the vehicle 10 can participate in a computing network or a cloud-based platform.

The cloud server and/or the vehicle network can provide the vehicle 10 with information that is crowdsourced from drivers, pedestrians, residents and others. For example, the cloud server and/or the vehicle network can inform the vehicle 10 of a live concert with potential for large crowds and traffic congestion along the path on or near the vehicle's 10 travel route. The cloud server and/or the vehicle network can also inform the vehicle 10 of potential pedestrians along the path on or near the vehicle's 10 travel route such as children getting off from school based on school location with respect to the vehicle's 10 navigation path and the current time. The cloud server and/or the vehicle network can also inform the vehicle 10 of conditions of general oncoming traffic, oncoming signs and lights, incoming lanes, restricted lanes, road closures, construction sites, potential vehicle encounters, accidents, and potential pedestrian encounters, etc.

The crowdsourced information obtained from the cloud server and/or the vehicle network can also include intersection geometry tags for locations pre-identified or computed to be difficult or poor visibility at junctions (based on geometric calculations, or crowdsourced data from other vehicle 10s). This type of information can be displayed as route selection(s) on the display device 18 as shown in FIG. 8.

The TCU can also inform the vehicle 10 of information received from a transportation network and/or a pedestrian network to receive information about pedestrian navigable area, such as a pedestrian walkway or a sidewalk, may correspond with a non-navigable area of a vehicle transportation network. This type of information can be displayed as route selection(s) on the device as shown in FIG. 5.

The vehicle network can include the one or more transportation networks that provides information regarding unnavigable areas, such as a building, one or more partially navigable areas, such as parking area, one or more navigable areas, such as roads, or a combination thereof. The vehicle 10 transportation network may include one or more interchanges between one or more navigable, or partially navigable, areas.

As stated, the vehicle 10 further comprises the on-board electronic control unit ECU, best illustrated in FIG. 2. The vehicle 10 can include more than one on-board ECUs for controlling different systems of the vehicle 10, although one is illustrated and described for simplicity. The ECU has a non-transitory computer readable medium. The ECU further includes the processor 20 programmed to perform control functions that will he further discussed below. The non-transitory computer medium preferably stores information such as navigation maps or road condition maps on the vehicle 10 for at least a period of time.

This information can be downloaded from the cloud server and/or the vehicle network server monthly, weekly, daily, or even multiple times in a drive, but would need to be stored locally for processing by the driver support system. Therefore, the non-transitory computer readable medium preferably stores regularly updated maps with information about activities that can be encountered by the vehicle 10, such as neighborhood information. The non-transitory computer medium preferably stores information that are downloaded from the cloud server and/or the vehicle network. This information is in conjunction with the real-time information acquired by the NAV (e.g., the GPS data). The processor 20 can control the automatic download of information from the cloud server and/or the vehicle network at regular intervals.

In the illustrated embodiment, the non-transitory computer readable medium stores predetermined information regarding conditions near the vehicle 10 vicinity. In particular, the non-transitory computer readable medium stores predetermined threshold information for displaying route selection(s) to the user, as will be further described below. The predetermined information can also include a database of road or navigation conditions, as will be further described below. The processor 20 controls the display device 18 to display route selection(s) based on information acquired by all the systems and components described above.

Referring now to FIGS. 5 and 6, the electronic display is provided in the vehicle 10 interior. The display device 18 is in connection with the ECU to receive control information from the ECU. The display device 18 can include a single type display, or multiple display types (e.g., both audio and visual) configured for human-machine interaction. The display device 18 include any type of display panel as desired to display route selection(s), navigation data and other information.

Therefore, the display device 18 can he one or more dashboard panels configured to display lights, text, images or icons. Alternatively, the display device 18 can include a heads-up display. Thus, the display device 18 can be directly mounted onto the vehicle 10 body structure, or mounted onto the windows panels. The display device 18 can alternatively be provided on a mobile device that is synced with the ECU of the vehicle 10. The display device 18 can have different shapes and sizes to accommodate the shape and contours of the vehicle 10.

As best seen in FIGS. 4 and 5, the display device 18 further includes a set of user input interfaces 24 to communicate with the driver. The display device 18 is configured to receive user inputs from the vehicle 10 occupants. The display device 18 can include, for example, control buttons and/or control buttons displayed on a touchscreen display (e.g., hard buttons and/or soft buttons) which enable the user to enter commands and information for use by the ECU to control various aspects of the vehicle 10. For example, input interface 24 provided to the display device 18 can be used by the ECU to monitor the climate in the vehicle 10, interact with the navigation system, control media playback, or the like. The input interface 24 can also he provided as a mobile device that is synced with the ECU so that the user can input selections or conditions to the mobile device. The display device 18 can also include a microphone that enables the user to enter commands or other information vocally. The display device 18 can further include one or more speakers that provide sound alerts and sound effects including computer-generated speech.

The user can input preferences for the navigation display system 22 via the input interface 24s. For example, the user can activate/deactivate the navigation display system 22 using the input interface 24s. The user can also select between versions or modes of the navigation display system 22 such as selecting icon preferences (e.g., size or location), display preferences (e.g., frequency of display, map based, icon based, etc.), sound OFF or sound only.

As stated, the display device 18 as part of the vehicle 10 navigation display system 22. In the illustrated embodiment, the navigation display system 22 comprises the electronic display device 18. The navigation display system 22 further includes the electronic control unit ECU having the processor 20 and the non-transitory computer readable medium storing predetermined information regarding conditions near the vehicle 10 vicinity. With the navigation display system 22, the processor 20 is programmed to control the electronic display device 18 to display route selection(s) regarding the vehicle 10 vicinity based on the predetermined information that is stored in the non-transitory computer readable medium.

The navigation display system 22 further comprises the vehicle 10 having the NAV that acquires information from the GPS unit and the TCU acquiring information from the cloud server and the vehicle network, In the illustrated embodiment, the processor 20 is programmed to automatically download information from the cloud services and the vehicle network to be stored in the non-transitory computer readable medium (daily, weekly, upon vehicle 10 ignition turning ON). This allows for the technical improvement of the vehicle 10 having the navigation display system 22 to not need to be connected to the cloud server or the vehicle network in real-time in order to be able to display information based on information received from the cloud server or the vehicle network.

The navigation display system 22 is provided to help inform drivers of recommended route and navigation selections to help reduce stress or burden on the driver. By utilizing information received by the TCU and NAV on a continuous basis, while also downloading conditions onto the on-board computer readable medium for at least a period of time, the navigation display system 22 of the vehicle 10 can be utilized as a low-cost application with limited need for continuous real-time sensing or detector use. This arrangement enables the technical improvement of allowing the on-board sensor network 12 to be utilized for a burden model of the navigation display system 22 to determine a burden state of the driver and/or passengers and control the display device 18 to display route selection(s) accordingly.

In the illustrated embodiment, the navigation display system 22 is controlled by the processor 20. The processor 20 can include any device or combination of devices capable of manipulating or processing a signal or other information now-existing or hereafter developed, including optical processors, quantum processors, molecular processors, or a combination thereof. For example, the processor 20 can include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or any combination thereof. As seen in FIG. 2, the processor 20 is operatively coupled with the computer readable medium, the input interface 24, the sensor network 12, the TCU, the NAV and the display device 18.

As used herein, the terminology “processor 20” indicates one or more processor 20s, such as one or more special purpose processor 20s, one or more digital signal processor 20s, one or more microprocessor 20s, one or more controllers, one or more microcontrollers, one or more application processor 20s, one or more Application Specific Integrated Circuits, one or more Application Specific Standard Products; one or more Field Programmable Gate Arrays, any other type or combination of integrated circuits, one or more state machines, or any combination thereof.

As used herein, the terminology “memory” or “computer-readable medium MEM” (also referred to as a processor-readable medium) indicates any computer-usable or computer-readable medium MEM or device that can tangibly contain, store, communicate, or transport any signal or information that may be used by or in connection with any processor 20. For example, the computer readable medium may be one or more read only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

Therefore, the computer-readable medium MEM further includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media can include, for example, optical or magnetic disks and other persistent memory. Volatile media may include, for example, dynamic random access memory (DRAM), which typically constitutes a main memory.

The computer readable medium can also be provided in the form of one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof.

The processor 20 can execute instructions transmitted by one or more transmission media, including coaxial cables, copper wire and fiber optics, including the wires that comprise a system bus coupled to a processor 20 of a computer. As used herein, the terminology “instructions” may include directions or expressions for performing any method, or any portion or portions thereof, disclosed herein, and may be realized in hardware, software, or any combination thereof.

For example, instructions may be implemented as information, such as a computer program, stored in memory that may he executed by a processor 20 to perform any of the respective methods, algorithms, aspects, or combinations thereof as described herein. In some embodiments, instructions, or a portion thereof, may be implemented as a special purpose processor 20, or circuitry, that may include specialized hardware for carrying out any of the methods, algorithms, aspects, or combinations thereof, as described herein. In some implementations, portions of the instructions may be distributed across multiple processor 20s on a single device, on multiple devices, which may communicate directly or across a network such as a local area network, a wide area network, the Internet, or a combination thereof.

Computer-executable instructions can be compiled or interpreted from computer programs created using a variety of programming languages and/or technologies, including, without limitation, and either alone or in combination, Java™, C, C++, Visual Basic, Java Script, Perl, etc. In general, the processor 20 receives instructions from the computer-readable medium MEM and executes these instructions, thereby performing one or more processes, including one or more of the processes described herein. Such instructions and other data may be stored and transmitted using a variety of computer-readable media.

For example, the processor 20 can also use information from the environmental sensors 16 to identify, the type of road (e.g., type of lanes and lane segments, urban or highway), difficulty of traversal of lane(s) and lane segment(s), density of traffic, the level of the density, etc.

In the illustrated embodiment, the processor 20 is programmed to anticipate information regarding upcoming conditions near the vehicle 10 vicinity based on one or more of the real-time information received from the on-board satellite navigation device NAV, the crowdsourced information and the predetermined information (stored in the computer readable medium). The processor 20 is programmed to predict and anticipate oncoming road conditions within the vehicle 10 vicinity based on the real-time information received from the on-board satellite navigation device NAV, the crowdsourced information and the predetermined information.

As stated, the non-transitory computer readable medium stores predetermined information. For example, the non-transitory computer readable medium includes one or more database of road conditions or situations. The database can include a set of road feature parameters that can be applicable for almost all navigation paths along a road feature or intersection (e.g., intersection type, ongoing traffic control(s), lane types and numbers, lane angles, etc.). The route selection(s) that is displayed can be accompanied with a concurrent notification of an upcoming scenario type, and/or a predicted estimated time to arrival (ETA).

Referring to FIG. 5, in the illustrated embodiment, the display device 18 can display a set of conditions for the driver to assess. The driver can input information regarding the drivers' conditions for the navigation display system 22 via the input interface 24. Preferably, the navigation display system 22 displays route selection(s) based on the conditions/information inputted by the user. For example, as seen in FIG. 5, the display device 18 can display a set of burden categories. The driver can input his or her current burden condition by inputting via the user input interface 24. The burden condition is considered a condition that can be inputted into the navigation display system 22.

As shown in FIG. 5, examples of input categories can include mood, energy level, anxiety level, urgency, driver experience and familiarity with the navigation area. It will be apparent to those skilled in the vehicle field from this disclosure that these categories are listed as examples only and that the navigation display system 22 is not limited to these categories. As shown, the driver can input burden values to the navigation display system 22 by selecting numbers on a scale (e.g., 1 to 10) that reflects burden level, energy level, urgency level, experience level, etc. The navigation display system 22 is programmed to display route selection(s) based on the burden values received from the user that is inputted.

Based on the driver's selection, the processor 20 can calculate an overall burden condition of the driver. For example, the driver can calculate the sum of the burden values that have been inputted by the driver. If the sum of the burden values exceeds a predetermined value (for example a predetermined value of eighteen when the driver inputs a value of three for each of the categories listed), then the processor 20 can be select routes requiring fewer navigation maneuvers or can eliminate routes undergoing construction or are subject to heavy traffic, etc. Therefore, the computer-readable memory can be programmed to store predetermined burden threshold values (e.g., eighteen or above) for comparing to the burden values that were inputted. In this way, the navigation display system 22 displays route selection(s) based on one or more burden conditions of the driver. The burden conditions can include any one of a user stress condition, user energy condition, and an urgency condition. The burden conditions further include a user experience level.

Alternatively, in the event that the driver does not input any burden conditions, the navigation display system 22 can operate in a default setting. In the default setting, the route selection(s) can be displayed based on the complexity of the route(s) that is calculated by the processor 20. For example, the processor 20 can also assign a complexity grade to route(s) based on crowdsourced information received from the cloud services and the vehicle network of FIG. 3. That is, the processor 20 is programmed to receive complexity information from the cloud services or the vehicle network via the telematics control unit TCU. For example, the TCU can acquire information that a particular route has been marked or reported by other drivers to be difficult or complicated.

The TCU can obtain crowdsourced information regarding that navigation route and so that the processor 20 can generate a complexity value having a series of grades for upcoming situations on all possible the navigation route(s). The processor 20 can use this information to then control the display device 18 to display route selection(s) of upcoming events as necessary and/or desired.

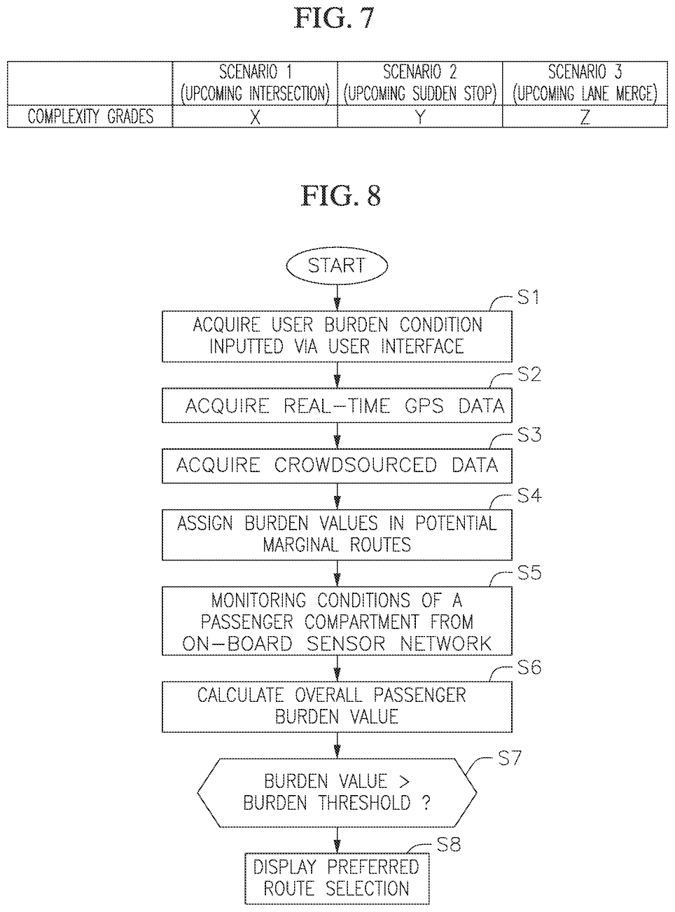

In this example, the complexity grades can be examples of predetermined information that is prestored in the non-transitory computer readable medium MEM. An example of a database of complexity grades is shown in FIG. 7. The processor 20 can match scenarios of different navigation routes with the scenarios in the database. The processor 20 can then add up the complexity grades of the scenarios that match and compare the sum of the complexity grades with the predetermined burden threshold values (e.g., eighteen or above) that are stored in the MEM.

If the assigned grades exceed the predetermined burden threshold values, such as 18 or above, then the processor 20 can control the display device 18 to display preferred route selection(s). The complexity grades can also be considered burden conditions for the navigation display system 22. Therefore, the processor 20 is programmed to control the electronic display device 18 to display default route selection(s) based on whether the burden value exceeds a predetermined complexity threshold.

In the illustrated embodiment, the user can preferably set the predetermined complexity threshold. For example, for the less adventurous driver, the driver can set the predetermined complexity threshold at a lower value. However, for a more adventurous driver who wants to familiarize him/herself with new routes or explore a new area, the driver can set the predetermined complexity threshold to he a higher value.

In the illustrated embodiment, scenarios for which the processor 20 can assign a complexity grade that can be stored in the MEM can include any or more infrastructure complexities such as any of the following: unprotected turns or road crossings; forced merges; multi-way stop signs; lane splits; left-lane exits; U-turns; traffic lights with right-turn-on-red allowed; crosswalk(s); bike-lane(s); railroad crossings; narrow roads; school zones; multi-lane road(s); short merge(s), roads with restricted lane(s) (e.g., bus lanes); destination on opposite side of street of route driven, etc.

Additional scenarios for which the processor 20 can assign a complexity grade that can be stored in the MEM can include scenarios involving road densities and likelihoods of conflict such as any of the following: dense-traffic road segment (currently, or historically); intersection(s) or roadway(s) which high incidence of accidents; locations where the MEM has stored historical conflicts (stop-and-go negotiation, emergency braking, etc.),

Additional scenarios for which the processor 20 can assign a complexity grade that can be stored in the MEM can include scenarios involving combinatorial complexities or time pressures such as any of the following: combinations of the above within a short section of the route; more than one lane change required in a short timespan or distance; more than one route instructions given in a short time or distance span, etc.

That is, the sample database of FIG. 7 can include any of the scenarios that are listed herein. In the illustrated embodiment, the processor 20 can assign a complexity grade to each of these scenarios. The processor 20 can calculate a sum of the complexity grades for potential navigation routes. The sum of the complexity grades can be considered an overall burden value for each of the potential navigation routes. In this way, the processor 20 can determine a burden value for one or more navigation routes based on the complexity grades of the individual scenarios of each navigation route.

As previously stated, the internal sensors 14 (e.g., microphones and cameras) are positioned to detect behavior of one or more passengers in the passenger compartment (e.g., whether the driver is distracted, unfocused or unresponsive). The navigation display system 22 can also display navigation route(s) based on a burden condition of the driver determined by the sensor network 12. In this way, the display device 18 can display route selection(s) that accounts for the burden condition of the driver and/or any of the passengers.

For example, the internal sensors 14 can detect whether the driver is distracted by another task, such as holding a mobile device or talking to someone. The internal sensors 14 can detect whether the driver is focused or looking at the road ahead or whether they are focused on other subjects. The processor 20 can then assess whether the driver is likely to become overburdened based in information detected by the internal sensors 14, such as detecting that the driver is glancing up and down from a map or a mobile device, detecting audible signs of confusion, sporadic acceleration and braking, etc.

The processor 20 can assess the degree or intensity of the burden condition of the driver based on one or more of the following factors or categories: center awareness, peripheral awareness, weighted visual awareness, aural awareness, touch awareness, soft support efficacy. The processor 20 can be programmed to give each of these factors a grade that can be a numerical value on a scale from zero (0) to ten (10), with zero being almost no burden and ten being very high burden. In situations of high burden (e.g., a burden grade of five to ten) the processor 20 can control the electronic display device 18 to modify the intensity of route selection(s) that is displayed based on the conditions regarding the passenger compartment of the vehicle 10. That is, the processor 20 can modify the route selection during navigation based on the burden condition of the driver that is detected by the on-board sensor network 12.

The processor 20 can modify a current navigation route by also taking into account information detected by the NAV, the TCU and the environmental sensors 16. For example, the processor 20 can heighten a grade of the selected navigation grade when determining an accident ahead. In this instance the processor 20 can control the display device 18 display an alternative route selection on the display device 18. The processor 20 can modify a current navigation route by also taking into account information detected by the internal sensor. For example, when the internal sensors 14 detect that the driver keeps deviating from the selected route or am having trouble following navigation instructions, the processor 20 in this instance the processor 20 can control the display device 18 display an alternative route selection on the display device 18.

Referring now to FIG. 10, a method for displaying route selection(s) to a driver of a vehicle 10 is illustrated. The method can be carried out by the processor 20. In step S1, the processor 20 can acquire burden conditions inputted to the user input interface 24 by a user. In step S2, the processor 20 can acquire real-time information from the NAV. In step S3, the processor 20 can acquire crowdsourced information from the TCU. In step S4, the processor 20 can assign burden values to potential navigation routes. As stated above, the processor 20 can assign burden values based on a sum of the complexity grades of scenarios that can be encountered for each navigation route.

In step S5, the processor 20 also monitors conditions regarding the passenger compartment from the on-board sensor network 12. In step S6, the processor 20 calculates an overall passenger burden value based on the user inputted data and the driver or passenger conditions determined by the on-board sensor network 12. In step S7, the processor 20 compares the overall passenger burden value to the predetermined burden threshold values in the MEM. In step S8, the processor 20 then controls the electronic display device 18 to display one or more route selection(s) based on the above-mentioned factors.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the navigation display system. Accordingly, these terms, as utilized to describe the present invention should be interpreted relative to a vehicle equipped with the navigation display system.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is clamed is:

1. A vehicle comprising:
a user input interface configured to allow a user to input one or more burden conditions of the user,
an electronic display device positioned in an interior compartment of the vehicle; and
a processor programmed to control the electronic display device to display one or more route selections, the one or more route selections being based on the burden conditions.

2. The vehicle according to claim 1, further comprising
an on-board satellite navigation device in communication with a global positioning system unit to acquire real-time information regarding conditions near the vehicle's vicinity, and
a telematics control unit in wireless communications to a cloud services or a vehicle network to upload and receive crowdsourced information regarding conditions near the vehicle's vicinity.

3. The vehicle according to claim 2, wherein
the one or more route selections are based on one or more of the real-time information, and the crowdsourced information.

4. The vehicle according to claim 2, wherein
the burden conditions include any one of a user stress condition, user energy condition, and an urgency condition.

5. The vehicle according to claim 4, wherein
the burden conditions further include a user experience level.

6. The vehicle according to claim 5, further comprising
an on-board sensor network that monitors conditions regarding the passenger compartment of the vehicle.

7. The vehicle according to claim 6, wherein
the processor controls the electronic display device to display one or more route selections based on information received by the on-board sensor network.

8. The vehicle according to claim 7, wherein
the on-board sensor network includes at least one internal camera positioned to detect behavior of one or more passengers in the passenger compartment.

9. The vehicle according to claim 7, wherein
the on-board sensor network includes at least one internal microphone positioned to detect behavior of one or more passengers in the passenger compartment.

10. The vehicle according to claim 2, wherein
the electronic display device is programmed to display a navigation map, the one or more route selections are superimposed on the navigation map.

11. A method for displaying vehicle route selections, the method comprising:
acquiring burden conditions inputted to a user input interface by a user;
acquiring real-time information from an on-board satellite navigation device in communication with a global positioning system unit;
acquiring crowdsourced information from a telematics control unit in wireless communications with at least one of a cloud services and a vehicle network; and
controlling an electronic display device to display one or more route selections, the one or more route selections being based on the burden conditions, the real-time information and the crowdsourced information.

12. The method according to claim 11, wherein
the burden conditions include any one of a user stress condition, user energy condition, and an urgency condition.

13. The method according to claim 12. wherein
the burden conditions further include a user experience level.

14. The method according to claim 13. further comprising
monitoring conditions regarding a passenger compartment of the vehicle from an on-board sensor network.

15. The method according to claim 14, further comprising
controlling the electronic display device to display one or more route selections based on information received by the on-board sensor network.

16. The method according to claim 15, wherein
the on-board sensor network includes at least one internal camera positioned to detect behavior of one or more passengers in the passenger compartment.

17. The method according to claim 16, wherein
the on-board sensor network includes at least one internal microphone positioned to detect behavior of one or more passengers in the passenger compartment.

18. The vehicle according to claim 17, further comprising
displaying the one or more route selections on the electronic display device as superimposed on a navigation map.
